(19) United States
(12) Patent Application Publication
(10) Pub. No.: US 2024/0232280 A1
(43) Pub. Date: Jul. 11, 2024

(54) INFORMATION PROCESSING DEVICE, INFORMATION PROCESSING METHOD, AND COMPUTER PROGRAM PRODUCT

(71) Applicant: KABUSHIKI KAISHA TOSHIBA, Tokyo (JP)

(72) Inventors: Tomoyuki SUZUKI, Shinagawa Tokyo (JP); Masaaki TAKADA, Kashiwa Chiba (JP)

(73) Assignee: KABUSHIKI KAISHA TOSHIBA, Tokyo (JP)

(21) Appl. No.: 18/498,222

(22) Filed: Oct. 31, 2023

(30) Foreign Application Priority Data
Jan. 10, 2023 (JP) 2023-001781

(51) Int. Cl. G06F 17/11

(52) U.S. Cl. CPC G06F 17/11

(57) ABSTRACT

According to one embodiment, an information processing device includes a memory and one or more processors. The memory stores time-series data including one or more variables. The one or more processors are coupled to the memory and configured to: calculate a time derivative value of each of the variables; calculate a difference indicating fluctuation of a long-term component of the corresponding variable based on a designated time sample interval; estimate a coefficient of a linear regression equation by machine learning using the time derivative value and the difference as learning data; and output the linear regression equation.

### CROSS-REFERENCE TO RELATED APPLICATIONS

This application is based upon and claims the benefit of priority from Japanese Patent Application No. 2023-001781, filed on Jan. 10, 2023; the entire contents of which are incorporated herein by reference.

### FIELD

Embodiments described herein relate generally to an information processing device, an information processing method, and a computer program product.

### BACKGROUND

Technologies for modeling physical phenomena are conventionally known. For example, there is a technology to apply a function identification problem, which is one type of machine learning, and to obtain a mathematical model that describes physical phenomena from time-series data.

However, with conventional technologies, it has been difficult to improve accuracy of generating a physical phenomenon model.

### BRIEF DESCRIPTION OF THE DRAWINGS

FIG. 1 is a diagram illustrating an example of a temperature prediction formula generated from time-series data;

FIG. 2 is a diagram for describing an example in which an error accumulates during long-term future prediction;

FIG. 3 is a diagram for describing an example in which an error accumulates during long-term future prediction;

FIG. 4A is a diagram illustrating an example of CFD results for a power electronics device that is naturally air-cooled;

FIG. 4B is a diagram illustrating the vertical axis of the graph of FIG. 4A as a logarithmic axis;

FIG. 5 is a diagram illustrating an example of physically appropriate coefficient estimation;

FIG. 6 is a diagram illustrating an example of a functional configuration of an information processing device of an embodiment;

FIG. 7 is a diagram illustrating an example of an error variance-covariance matrix of Formula (11) and an error variance-covariance matrix of Formula (15);

FIG. 8 is a diagram for describing an example of mixing two long-term components;

FIG. 9 is a diagram illustrating an example of a method of mixing two long-term components;

FIG. 10 is a diagram illustrating an example of an error variance-covariance matrix when two long-term components are mixed;

FIG. 11 is a diagram illustrating a first example of effects when two long-term components are mixed;

FIG. 12 is a diagram illustrating a second example of effects when two long-term components are mixed;

FIG. 13 is a flowchart illustrating an example of a method of generating a model of the embodiment; and

FIG. 14 is a diagram illustrating an example of a hardware configuration of the information processing device of the embodiment.

### DETAILED DESCRIPTION

In general, according to one embodiment, an information processing device includes a memory and one or more processors. The memory stores time-series data including one or more variables. The one or more processors are coupled to the memory and configured to: calculate a time derivative value of each of the variables; calculate a difference indicating fluctuation of a long-term component of the corresponding variable based on a designated time sample interval; estimate a coefficient of a linear regression equation by machine learning using the time derivative value and the difference as learning data; and output the linear regression equation.

Exemplary embodiments of an information processing device, an information processing method, and a computer program product will be described in detail below with reference to the accompanying drawings. The present invention is not limited to the following embodiments.

There is a method of simply simulating a phenomenon by dividing a complex product/system into a plurality of elements and modeling the relationship of each element. This method applies an equivalent circuit for solving an electric circuit to heat and fluid problems. For example, the method for heat is called a thermal network method, and energy conservation at each node is expressed by the following Formula (1).

$${\sum }_{\begin{matrix}j = 1 \\ j \neq i\end{matrix}}^{N} \frac{1}{{R}_{ij}^{( m )}} ( {T}_{i}^{( m )} - {T}_{j}^{( m )} ) = {Q}_{i}^{( m )} - \frac{{C}_{i}^{( m )}}{Δ t} ( {T}_{i}^{( m )} - {T}_{i}^{( m - 1 )} ) \qquad ( 1 )$$

Here, C is heat capacity, R is heat resistance, Q is calorific value, and N is the number of nodes. By transforming the above Formula (1), the differential equation shown in the following Formula (2) is obtained.

$$\frac{{dT}_{l}}{dt} = \frac{1}{{C}_{l}} \{ {Q}_{i} + {\sum }_{{j = 1}_{j \neq l}}^{N} \frac{1}{{R}_{ij}} ( {T}_{j} - {T}_{i} ) \} \qquad ( 2 )$$

When constructing the above Formula (2) deductively, an actual phenomenon and structure are simplified from the viewpoint of physics, and heat resistance, heat capacity, and the like are set. Heat resistance depends not only on the shape and physical properties, but also on state quantities such as temperature and speed thereof. In many cases, there is no theoretical formula, and when there is no theoretical formula, it is necessary to set a formula suitable for the object from among a large number of candidates for empirical formulas.

In sparse identification of nonlinear dynamics (SINDy), which is a development of the function identification problem, under the assumption that a true model can be expressed by a linear combination of nonlinear functions, a time derivative of the variable vector X is given in the form of the following Formula (3).

$$\dot{X} = Θ ( X ) Ξ \qquad ( 3 )$$

Here, X is an m×n matrix. m is the number of time samples, and n is the dimension of the variable X. θ(X) is called a library and includes nonlinear function candidates. Ξ is a vector of sparse coefficients. Coefficients (components of Ξ) corresponding to nonlinear functions not selected as a basis function are represented by 0.

If the library is configured in a form proportional to either term of the above Formula (2), in the application of sparse identification of nonlinear dynamics (SINDy), the temperature prediction formula different for each object (above Formula (2)) can be generated from the time-series data by the following Formula (4).

$$\frac{dT}{dt} = Θ ( T , X ) Ξ \qquad ( 4 )$$

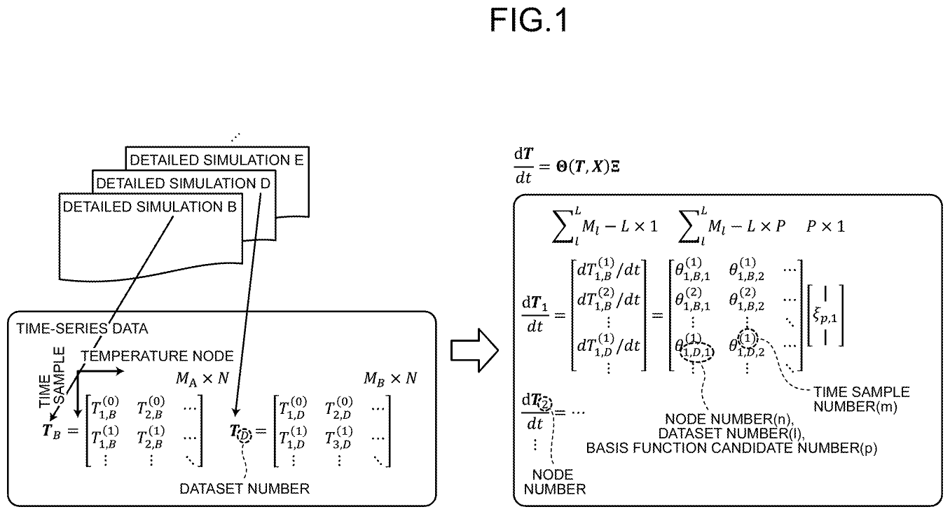

FIG. 1 is a diagram illustrating an example of the temperature prediction formula generated from the time-series data. For example, the time-series data T_{B} is data based on data set B obtained from detailed simulation B. The row of the time-series data T_{B} corresponds to the time sample. The column of the time-series data T_{B} corresponds to the node of the temperature prediction target.

The left side of the temperature prediction formula indicates the time derivative for each node of the temperature prediction target. Each component of θ(X) is represented by a number m identifying the time sample, a number n identifying the node, a number 1 identifying the data set, and a number p identifying the basis function candidate. The column vector included in θ(X) is the basis function candidate. Ξ is a vector that determines coefficients of the basis function.

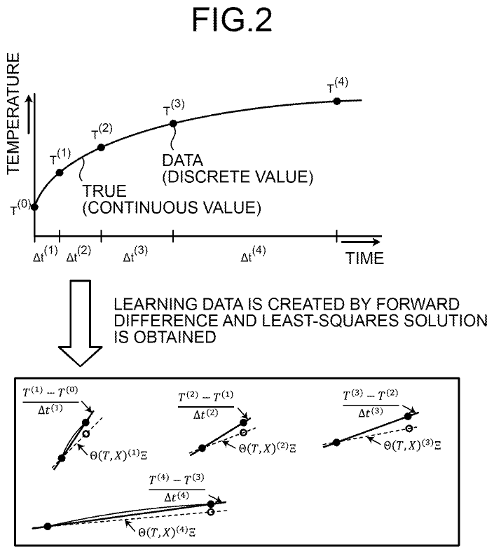

However, from the time derivative of X and θ(X) calculated from the time-series data, the desired formula cannot be obtained from the above Formula (2) generated by sequential thresholded least-squares algorithm (STLS), which is a sparse estimation method proposed in S. L. Brunton, J. L. Proctor, J. N. Kutz, “Discovering governing equations from data by sparse identification of nonlinear dynamical systems”, Proc. Natl. Acad. Sci., 113 (2016), pp. 3932-3937. The reason for this is that when the time-series data is changed into the form of the ordinary differential equation of the above Formula (4), each data is treated independently, which will be described in more detail using FIG. 2.

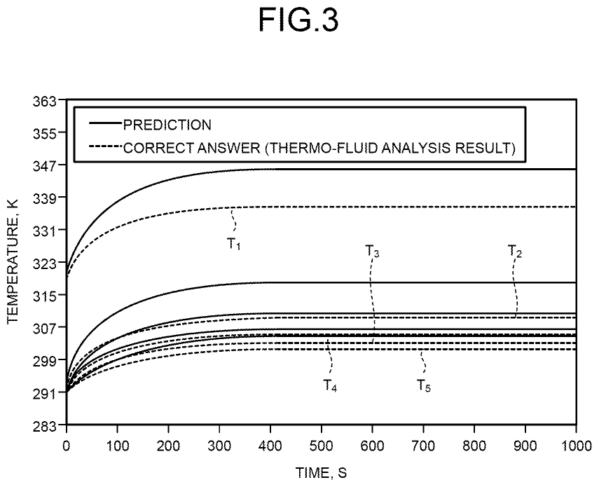

FIGS. 2 and 3 are diagrams for describing an example in which an error accumulates during long-term future prediction. FIG. 2 illustrates an example of calculating a least-squares solution with learning data created by forward difference by using data of discrete values. In this case, since it is difficult to consider positive and negative of the error and positive and negative of the error may be biased, when executing long-term future prediction by the generated prediction formula, for example, an error accumulates as illustrated in FIG. 3 (Problem 1).

For example, when A: error 1=50, error 2=15, B: error 1=60, error 2=−20, the sum-of-squares error of each is 2725 for A and 4000 for B, making A a better estimation result than B. However, the cumulative error is 65 for A and 40 for B, making B more advantageous. There can also be a method of devising the error function, which however becomes a very complicated process because the order of data is considered, and there are problems such as an increase in learning time.

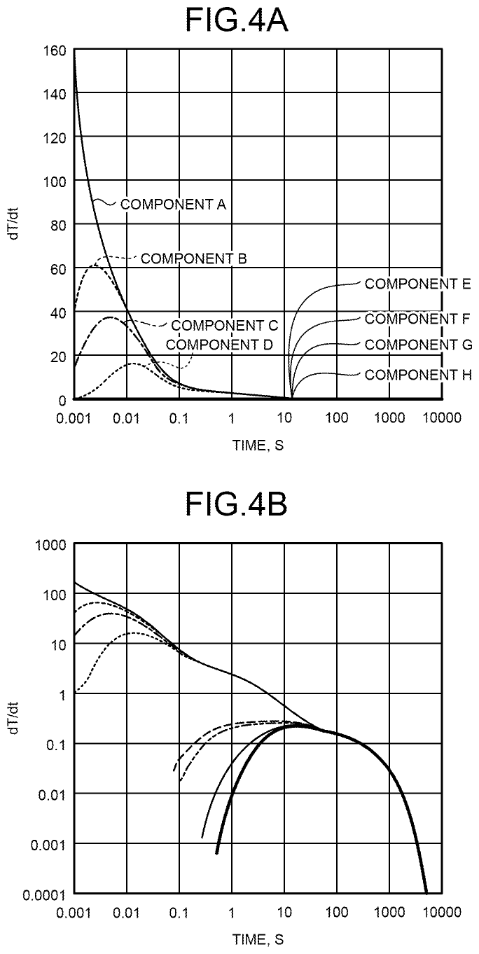

In addition, as engineering problems, a problem that the influence of some data is very strong is likely to occur. This problem will be described with reference to FIGS. 4A and 4B.

FIG. 4A is a diagram illustrating an example of computational fluid dynamics (CFD) results of a power electronics device that is naturally air-cooled. FIG. 4B is a diagram illustrating the vertical axis of the graph of FIG. 4A as a logarithmic axis. In general, the time sample Δt is taken smaller as the temperature change increases. As illustrated in FIGS. 4A and 4B, since the temperature change is more intense in the time zone when Δt is smaller, the influence of some data is very strong (problem 2). Appropriate weighting of data is required, but it is difficult to solve this problem by data normalization (including taking logarithm) and devising the error function (relative error, and the like).

To solve the problem 2, it is necessary to consider the correlation between the error terms, and it is required to introduce ideas such as generalized least squares (GLS). In GLS, a variance-covariance matrix Q for the error terms (following Formula (5)) is assumed.

$$Ω = [ \begin{matrix}{σ}_{11} & {σ}_{12} & … & {σ}_{1 N} \\ {σ}_{21} & {σ}_{22} & … & {σ}_{2 N} \\ ⋮ & ⋮ & ⋱ & ⋮ \\ {σ}_{N 1} & {σ}_{N 2} & … & {σ}_{NN}\end{matrix} ] \qquad ( 5 )$$

If y=Xβ+ε, ε to N(0, σ²Ω), then the estimator is the following Formula (6).

$$\begin{matrix}\hat{β} = {{argmin}_{β} ( y - X β )}^{T} {Ω}^{- 1} ( y - X β ) \\ = {argmin}_{β} {\sum }_{i = 1}^{N} {\sum }_{j = 1}^{N} {( {Ω}^{- 1} )}_{ij} ( {y}_{i} - {X}_{i} β ) ( {y}_{j} - {X}_{j} β )\end{matrix} \qquad ( 6 )$$

If one of the diagonal elements of the variance-covariance matrix Q is 1 and the other is 0, that is, for a unit matrix, the least squares method is used. It is necessary to give the covariance component appropriately. To execute generalized least squares method, it is necessary to know the variance-covariance matrix Q. However, the cases where the variance-covariance matrix Q is known in advance are limited.

Here, when predicting the temperature, for example, the following Formula (7) is used.

$$[ \begin{matrix}{T}_{1}^{( 1 )} \\ {T}_{1}^{( 2 )} \\ {T}_{1}^{( 3 )} \\ ⋮\end{matrix} ] = [ \begin{matrix}{T}_{1}^{( 0 )} \\ {T}_{1}^{( 1 )} \\ {T}_{1}^{( 2 )} \\ ⋮\end{matrix} ] + [ \begin{matrix}{\dot{T}}_{1}^{( 1 )} Δ {t}^{( 1 )} \\ {\dot{T}}_{1}^{( 2 )} Δ {t}^{( 2 )} \\ {\dot{T}}_{1}^{( 3 )} Δ {t}^{( 3 )} \\ ⋮\end{matrix} ] \qquad ( 7 )$$

The state update amount is the product of the time derivative of T₁ and Δt, and since Δt is not constant, considering the error by the following Formula (8), this is insufficient when considering the accumulation of error in the long-term future prediction.

$$ε = \frac{dT}{dt} - Θ ( T , X ) Ξ \qquad ( 8 )$$

Therefore, Japanese Patent Application Laid-open No. 2022-167097 proposes a method of executing learning that considers the arrangement of data by devising a data preprocessing method.

Consider discretizing the right side of the following Formula (9) of the temperature node 1 by the following Formula (10) with first-order accuracy forward difference.

$$\frac{{dT}_{1}}{dt} = {Θ}_{1} ( T , X ) {Ξ}_{1} \qquad ( 9 )$$

$$\begin{matrix}[ \begin{matrix}{T}_{1}^{( 1 )} \\ {T}_{1}^{( 2 )} \\ {T}_{1}^{( 3 )} \\ ⋮\end{matrix} ] = [ \begin{matrix}{T}_{1}^{( 0 )} \\ {T}_{1}^{( 1 )} \\ {T}_{1}^{( 2 )} \\ ⋮\end{matrix} ] + [ \begin{matrix}{\dot{T}}_{1}^{( 1 )} Δ {t}^{( 1 )} \\ {\dot{T}}_{1}^{( 2 )} Δ {t}^{( 2 )} \\ {\dot{T}}_{1}^{( 3 )} Δ {t}^{( 3 )} \\ ⋮\end{matrix} ] = \\ [ \begin{matrix}{T}_{1}^{( 0 )} \\ {T}_{1}^{( 1 )} \\ {T}_{1}^{( 2 )} \\ ⋮\end{matrix} ] + [ \begin{matrix}{{Θ}_{1} ( T , X )}^{( 1 )} Δ {t}^{( 1 )} \\ {{Θ}_{1} ( T , X )}^{( 1 )} Δ {t}^{( 1 )} + {{Θ}_{1} ( T , X )}^{( 2 )} Δ {t}^{( 2 )} \\ {{Θ}_{1} ( T , X )}^{( 1 )} Δ {t}^{( 1 )} + {{Θ}_{1} ( T , X )}^{( 2 )} Δ {t}^{( 2 )} + {{Θ}_{1} ( T , X )}^{( 3 )} Δ {t}^{( 3 )} \\ ⋮\end{matrix} ] {Ξ}_{1}\end{matrix} \qquad ( 10 )$$

The above Formula (10) can be transformed into the following Formula (11).

$$Δ {T}_{1 , t = 0} = [ {T}_{1 , l}^{( i )} - {T}_{1 , l}^{( 0 )} ] = [ {\sum }_{m = 1}^{i} {{Θ}_{1 , l} ( T , X )}^{( m )} Δ {t}_{l}^{( m )} {Ξ}_{1} ] , i = 1 , 2 , … {M}_{l} - 1 , l = 1 , 2 , … L \qquad ( 11 )$$

Japanese Patent Application Laid-open No. 2022-167097 takes notice that the coefficient vector Ξ of the above Formulas (4) and (11) (Ξ₁ of Formula (11) is a component of the temperature node 1 of Ξ) is common, and proposes a method of machine learning using mixed data of the above Formulas (4) and (11) calculated from the time-series data.

The following Formula (12) can be derived by considering the least-squares solution of the above Formula (11). It can be seen that the following Formula (12) has an interaction term.

$${Ξ}_{1} = {argmin}_{{S}_{1}} {\sum }_{l}^{L} \text{?} \{ \sum \text{?} ( M \text{?} - l + 1 ) ( T \text{?} - T \text{?} - Θ \text{?} {( T , X )}^{( 1 )} Δ t \text{?} {Ξ}_{1} ) \text{?} + \sum \text{?} \sum \text{?} 2 ( M \text{?} - i + 1 ) ( T \text{?} - T \text{?} - Θ \text{?} ( T , X ) \text{?} Δ t \text{?} {Ξ}_{1} ) ( T \text{?} - T \text{?} - Θ \text{?} {( T , X )}^{( f )} Δ \text{?} {Ξ}_{1} ) \} \qquad ( 12 )$$

$$\text{?} \text{indicates text missing or illegible when filed}$$

The interaction term of the above Formula (12) indicates that the variance-covariance matrix of the error term can be incorporated by devising the preprocessing, like the generalized least squares method. Furthermore, this method allows selection of interacting error terms to some extent (not across data sets and the like). Therefore, physically appropriate coefficient estimation can be implemented.

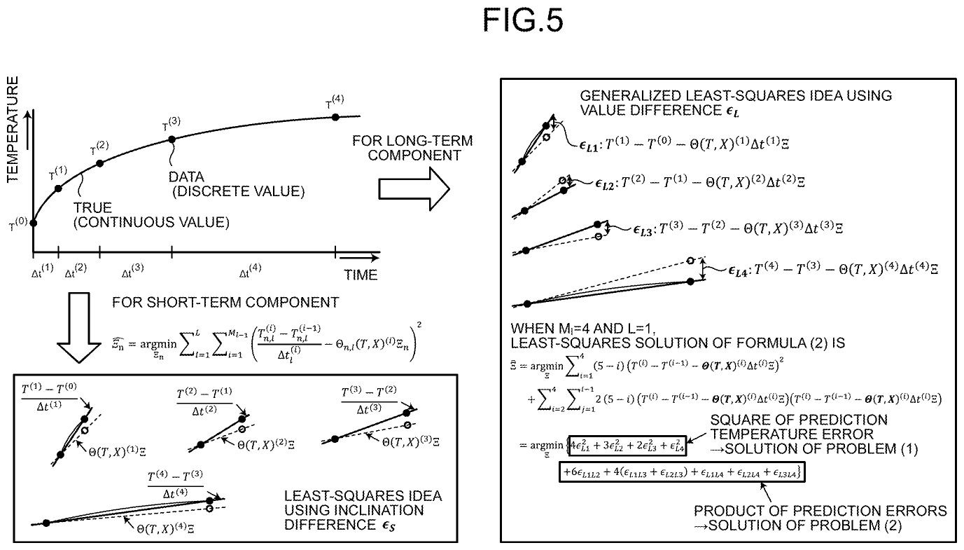

FIG. 5 is a diagram illustrating an example of physically appropriate coefficient estimation. The short-term component improves prediction accuracy one move ahead by the least-squares idea. The long-term component improves long-term future prediction accuracy by the generalized least-squares idea.

By normalizing, then mixing, and learning the short-term component of the above Formula (4) and the long-term component of the above Formula (11) as the following Formula (13), efficient learning becomes possible. Here, al is a vector indicating different values for each node n. For example, the first component of α1 indicates the value of node 1, and the second component of α1 indicates the value of node 2.

$${\sum }_{l = 1}^{L} {\sum }_{i = 1}^{{M}_{l} - 1} ( \frac{{T}_{1 , l}^{( i )} - {T}_{1 , l}^{( i - 1 )}}{Δ {t}_{l}^{( i )}} ) = {α}_{1} {\sum }_{l = 1}^{L} {\sum }_{i = 1}^{{M}_{i} - 1} ( {T}_{1 , l}^{( i )} - {T}_{1 , l}^{( 0 )} ) \qquad ( 13 )$$

However, Japanese Patent Application Laid-open No. 2022-167093 using the above Formula (12) has the following two problems 3 and 4.

The problem 3 is weight (M₁−i+1). This weight indicates that the earlier the time zone is (earlier sample time), the greater weight (M₁−i+1) is attached to the error. Here, M₁ indicates the number of data of data set 1.

The problem 4 is taking the product of the error between sample times that are far apart.

Considering an example, the variance-covariance matrix Ω⁻¹ is the following Formula (14), and the point that the larger the row and column numbers are (later sample time), the smaller the weight is corresponds to the problem 3. The point that weight (≠0) is attached to an element with a large n difference between the row number and the column number corresponds to the problem 4.

$${Ω}^{- 1} = [ \begin{matrix}4 & 6 & 4 & 1 \\ 6 & 3 & 4 & 1 \\ 4 & 4 & 2 & 1 \\ 1 & 1 & 1 & 1\end{matrix} ] \qquad ( 14 )$$

Details of an operation example of the information processing device of the embodiment that can further improve the accuracy of generating the physical phenomenon model will be described below.

### Example of Functional Configuration

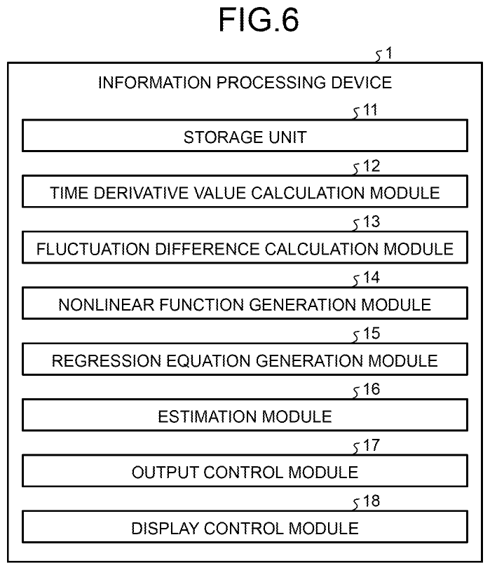

FIG. 6 is a diagram illustrating an example of a functional configuration of an information processing device 1 of the embodiment. The information processing device 1 of the embodiment includes a storage unit 11, a time derivative value calculation module 12, a fluctuation difference calculation module 13, a nonlinear function generation module 14, a regression equation generation module 15, an estimation module 16, an output control module 17, and a display control module 18.

The storage unit 11 stores the time-series data including at least one of a dependent variable and an independent variable. The dependent variable (objective variable) is a variable determined depending on the independent variable (explanatory variable). The independent variable is a variable indicating a factor of a change in the dependent variable. The dependent variable is, for example, temperature of an electronic component, heat sink, and the like. The independent variable is, for example, the wind speed indicating wind strength of a fan cooling an electronic component, a current flowing through an electronic component, a voltage input to an electronic component, and the like.

In the information processing device 1 of the embodiment, the value of the dependent variable is represented in units unified for each physical quantity indicated by the dependent variable. For example, when the physical quantity is weight, the dependent variable represented by kg and the dependent variable represented by g are not mixed and unified into kg or g. Similarly, the value of the independent variable is represented in units unified for each physical quantity indicated by the independent variable.

Note that the storage unit 11 may store a plurality of types of time-series data. Δt least one of an initial condition and boundary condition may be different for the plurality of types of time-series data.

The time derivative value calculation module 12 calculates the time derivative value of the variable included in the time-series data (dependent variable or independent variable). The time derivative value of the variable included in the time-series data is used as learning data represented in the form of the above Formula (4).

The fluctuation difference calculation module 13 calculates the difference indicating fluctuation of the long-term component of the variable included in the time-series data. Specifically, the fluctuation difference calculation module 13 discretizes the left side of the above Formula (4) with first-order accuracy, for example, forward differentiation, and calculates the above Formula (10).

Here, the fluctuation difference calculation module 13 calculates the difference indicating the fluctuation of the long-term component by transforming the above Formula (10) into the following Formula (15). Note that in Japanese Patent Application Laid-open No. 2022-167097, by transforming the above Formula (10) into the above Formula (11), the difference indicating the fluctuation from the initial value of the variable is calculated.

$${ΔT}_{1} \text{?} = [ T \text{?} - T \text{?} ] = \sum \text{?} Θ \text{?} ( T , X ) \text{?} Δ \text{?} Ξ \text{?} ] , \text{?} = 1 , 2 , … M \text{?} / {t}_{m} ∈ ℤ , l = 1 , 2 , … L \qquad ( 15 )$$

$$\text{?} \text{indicates text missing or illegible when filed}$$

Considering the least-squares solution of the above Formula (15), the following Formula (16) can be derived. It can be seen that Formula (16) also has an interaction term.

$$\text{?} = argmin \text{?} {\sum }^{L} \text{?} \{ {\sum }^{M} \text{?} {T}_{1}^{( m )} \text{?} - {T}_{1}^{( m - 1 )} \text{?} - Θ \text{?} {( T , X )}^{( m )} {Δt}_{l}^{( m )} ε \text{?} ) \text{?} + \qquad ( 16 )$$

$$\sum \text{?} \sum \text{?} {\sum }_{k =} \text{?} ( {T}_{1}^{( i )} \text{?} - T \text{?} - {Θ}_{1} \text{?} ( T , X ) \text{?} Δt \text{?} ) ( T \text{?} - T \text{?} - Θ \text{?} {( T , X )}^{( k )} Δ {t}^{( k )} \text{?} {Ξ}_{1} ) \}$$

$$\text{?} \text{indicates text missing or illegible when filed}$$

It can be seen that the earlier the time zone is (earlier sample time), the less weight is attached to the error (solution of problem 3). Furthermore, the influence range of the interaction term can be controlled by tₘ of the above Formulas (15) and (16) (solution of problem 4).

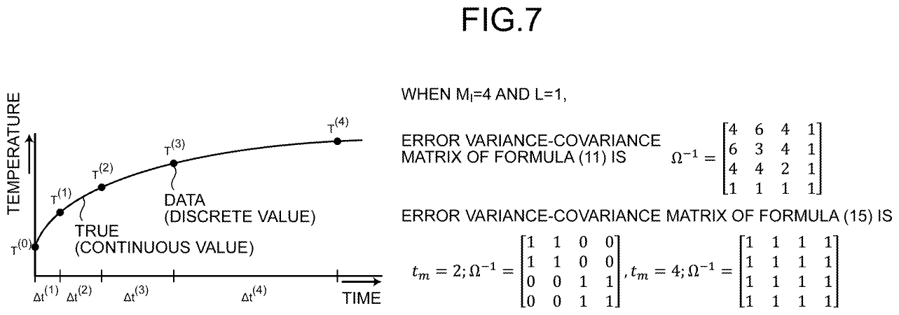

FIG. 7 is a diagram illustrating an example of the error variance-covariance matrix of Formula (11) and the error variance-covariance matrix of Formula (15).

However, the method using Formula (15) alone has a problem of tradeoffs because the smaller tₘ is, the following two points hold.
The ratio (number) of the interaction term decreases (1:(tₘ−1)/2).
It is possible to evaluate the error between sample points that are close in time.

In a case where tₘ=M₁:
tₘ=2; main effect term: 2, interaction term: ₜₘC₂=tₘ(tₘ−1)/2=1;
tₘ=4; main effect term: 4, interaction term: 6;
tₘ=10; main effect term: 10, interaction term: 45;
tₘ=20; main effect term: 20, interaction term: 190; and
tₘ=50; main effect term: 50, interaction term: 1125.

Therefore, the information processing device 1 of the embodiment mixes and learns two or more types of differences indicating fluctuation of the long-term component of the above Formula (15). That is, the fluctuation difference calculation module 13 calculates the differences indicating the fluctuation of the long-term component based on two or more types of time sample intervals.

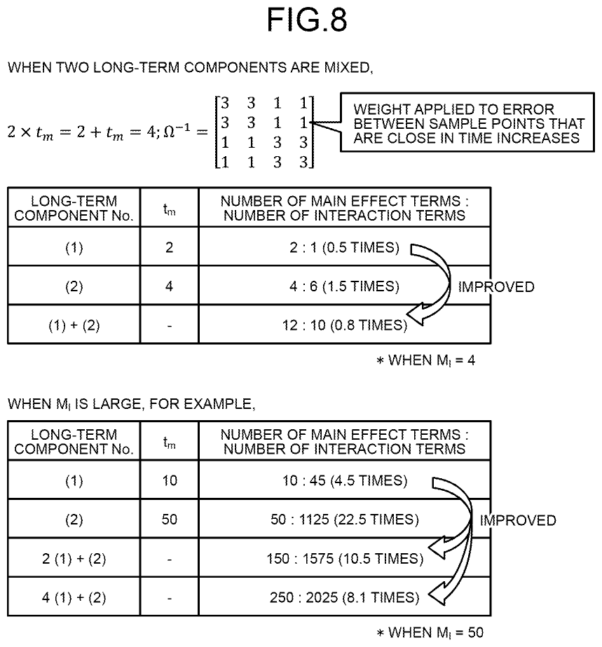

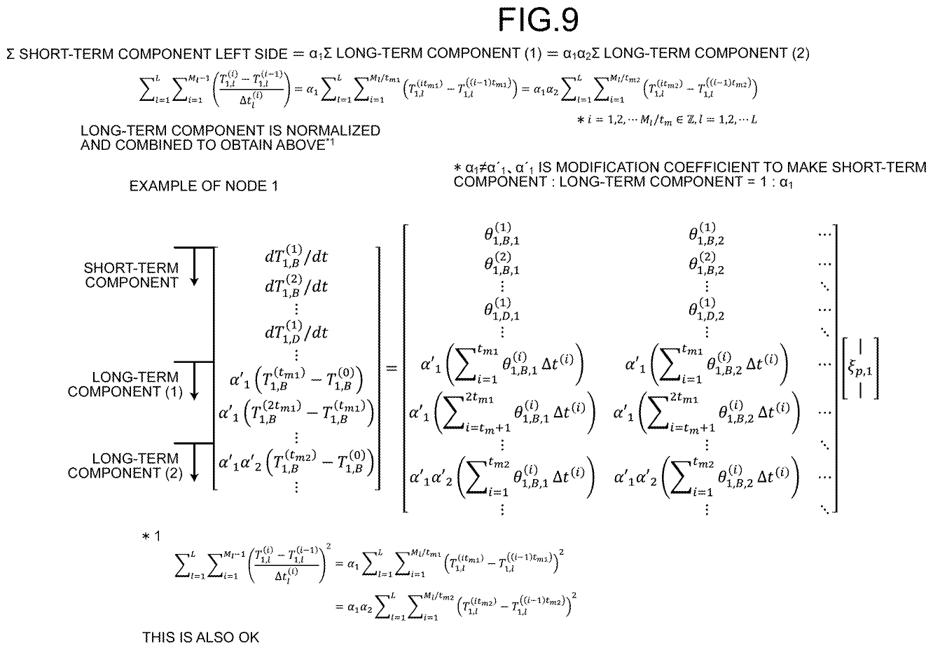

FIGS. 8 and 9 are diagrams for describing an example in which two long-term components are mixed. When two long-term components are mixed, in the variance-covariance matrix Ω⁻¹, the weight applied to the error between sample points that are close in time increases. The number of interaction terms increases, and the ratio of the number of main effect terms to the number of interaction terms improves.

The two long-term components are, for example, normalized and combined by coefficients α₁ and α₂, as illustrated in FIG. 9. The sum total of time derivative values included in the learning data is made larger than the sum total of differences indicating the fluctuation of the long-term component by the coefficients α₁ and α₂.

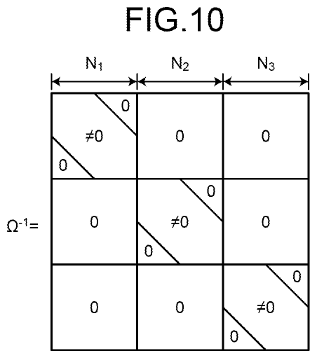

FIG. 10 is a diagram illustrating an example of the error variance-covariance matrix Ω⁻¹ when the two long-term components are mixed. Regions N₁ to N₃ of columns of the variance-covariance matrix Ω⁻¹ are data corresponding to detailed numerical analysis or each condition of experiment. As illustrated in FIG. 10, the error variance-covariance matrix Ω⁻¹ has non-zero values near the diagonal components.

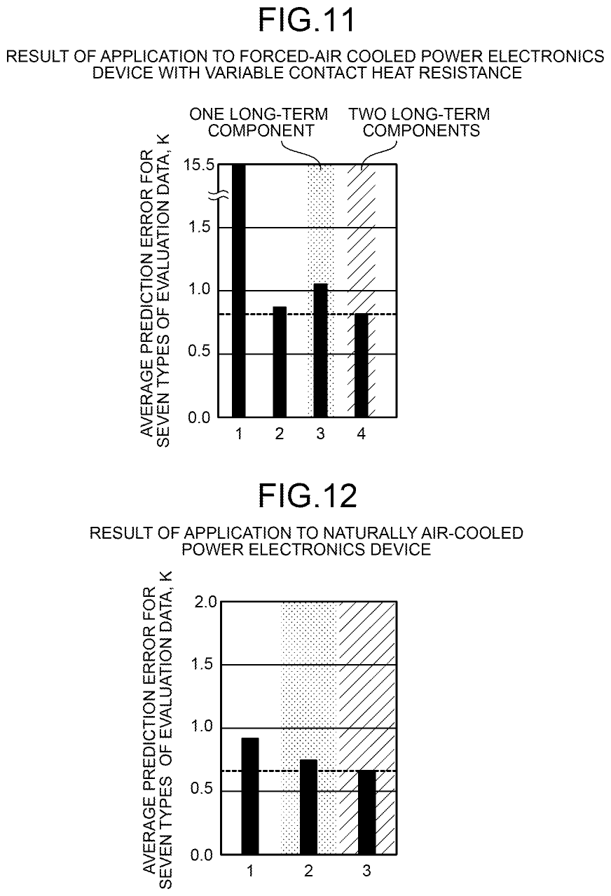

FIG. 11 is a diagram illustrating a first example of effects when the two long-term components are mixed. FIG. 11 illustrates an example of application to a forced air-cooled power electronics device with variable contact heat resistance. The vertical axis illustrates the average prediction error for seven types of evaluation data simulated with different boundary conditions and heat generation conditions.

Data 1 on the horizontal axis illustrates the case where the learning data without long-term components is used. Data 2 on the horizontal axis illustrates the case where the learning method of Japanese Patent Application Laid-open No. 2022-167097 (method using the difference indicating fluctuation from the initial value of the variable) is used. Data 3 on the horizontal axis illustrates the case where the learning data including one long-term component is used. Data 4 on the horizontal axis illustrates the case where the learning data including two long-term components is used.

As illustrated in FIG. 11, the average prediction error can be best suppressed when the learning data including the two long-term components are used.

FIG. 12 is a diagram illustrating a second example of effects when two long-term components are mixed. FIG. 12 illustrates an example of application to a naturally air-cooled power electronics device. The vertical axis illustrates the average prediction error for seven types of evaluation data simulated with different boundary conditions and heat generation conditions.

Data 1 on the horizontal axis illustrates the case where the learning method of Japanese Patent Application Laid-open No. 2022-167097 (method using the difference indicating fluctuation from the initial value of the variable) is used. Data 2 on the horizontal axis illustrates the case where the learning data including one long-term component is used. Data 3 on the horizontal axis illustrates the case where the learning data including two long-term components is used.

As illustrated in FIG. 12, the average prediction error can be best suppressed when the learning data including the two long-term components are used.

Returning to FIG. 6, the nonlinear function generation module 14 generates a nonlinear function based on at least one of the dependent variable and the independent variable. The nonlinear function generation module 14 generates the nonlinear function, for example, based on the temperature Tᵢ at the position i and the temperature Tⱼ at the position j.

The regression equation generation module 15 generates a linear regression equation with the nonlinear function generated by the nonlinear function generation module 14 as a basis function.

The estimation module 16 estimates the coefficient of the linear regression equation generated by the regression equation generation module 15 by the machine learning using the time derivative value and the two or more types of differences indicating the fluctuation of long-term components as learning data. Specifically, the estimation module 16 estimates the coefficient of the linear regression equation by the machine learning by using both the learning data represented in the form of the above Formula (4) and the learning data that is a mixture of two or more types of differences indicating the fluctuation of the long-term component of the above Formula (15).

Note that if only the short-term component is considered, the long-term future prediction accuracy of the model will deteriorate. Conversely, if only the long-term component is considered, the short-term future prediction accuracy of the model will deteriorate, and the short-term future prediction will not be correct, deteriorating the long-term future prediction accuracy of the model as well.

Note that since the least squares method used in the machine learning is a weighted sum method that ignores weight adjustment, as illustrated in FIG. 9 described above, preprocessing the learning data is important to further improve the accuracy of the model.

In the example of the embodiment, since the candidate basis function includes, for example, addition and subtraction between variables, and results of those operations have physical meanings, inconvenience occurs when the variables (dependent variable and independent variable) are normalized. Therefore, the estimation module 16 estimates the linear regression equation coefficient by the machine learning method that does not require normalization of the variables. Note that there can also be a method of normalizing the basis function itself. In such a case, it is necessary to consider that the learning data is a mixture of short-term components with large variance and the long-term component.

When a predetermined convergence condition is satisfied, the output control module 17 outputs the linear regression equation represented by the modified coefficient. The predetermined convergence condition is, for example, the number of iterations of the machine learning process and the like.

The display control module 18 displays display information on a display device. For example, the display control module 18 displays the linear regression equation output by the output control module 17. For example, the display control module 18 displays basis function candidates on the display device, and receives designation of the basis function used to generate the linear regression equation (for example, column vector included in the library θ(X) of the above Formula (3)) from the basis function candidates. For example, the display control module 18 displays, on the display device, display information to receive designation of the time sample interval used to calculate the difference indicating fluctuation of the long-term component of the variable.

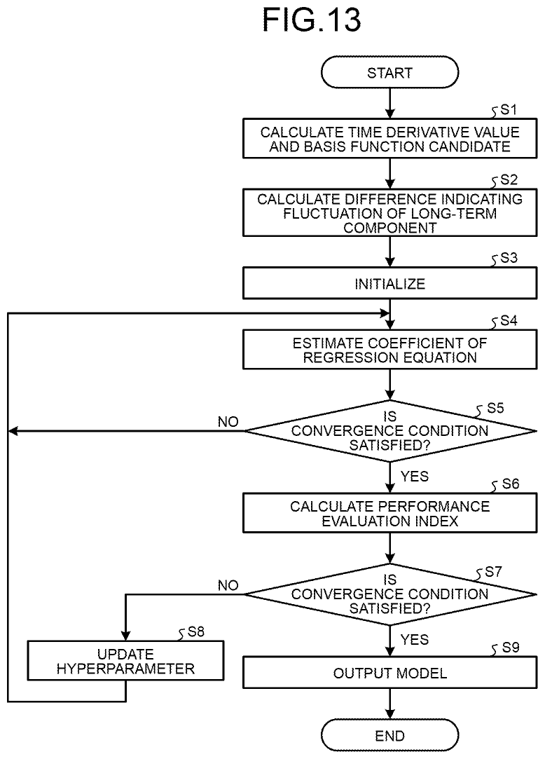

Example of method of generating model FIG. 13 is a flowchart illustrating an example of a method of generating a model of the embodiment. To begin with, the time derivative value calculation module 12 calculates the time derivative value of the variable included in the time-series data (dependent variable or independent variable) and the basis function candidate (step S1). Next, the fluctuation difference calculation module 13 calculates two or more types of differences indicating fluctuation of the long-term component (step S2).

Next, the information processing device 1 initializes data to be used when executing machine learning on the model (for example, hyperparameters and the like) (step S3).

Next, the estimation module 16 estimates the coefficient of the linear regression equation generated by the regression equation generation module 15 by the machine learning using the time derivative value calculated in step S1 and two or more types of differences calculated in step S2 as learning data (step S4). Specifically, the time derivative value of the variable included in the time-series data is used as the learning data in the form of above Formula (4), and the difference indicating the fluctuation of the long-term component of the variable included in the time-series data is used as the learning data in the form of FIG. 9 described above.

For the learning data used for the estimation process of step S4, for example, some data may be selected at random from the entire learning data. For example, the learning data used for the estimation process of step S4 may be selected in order from unused data included in the learning data.

Next, the estimation module 16 determines whether the result of the coefficient estimation process satisfies the convergence condition (step S5). The convergence condition is, for example, the number of times the coefficient estimation process is executed. Note that the process of step S5 is not mandatory and the process of step S5 may be skipped.

When the convergence condition is not satisfied (step S5, No), the process returns to step S4. When the convergence condition is satisfied (step S5, Yes), the output control module 17 calculates a performance evaluation index of the model (step S6). For example, the performance evaluation index is an index for selecting models, such as information criterion. In general, the performance evaluation index is an index that weighs the degree of fit to the model against the simplicity of the model.

Next, the output control module 17 determines whether the learned model satisfies the convergence condition (step S7). The convergence condition is, for example, the number of times the model learning process (steps S4 to S6) is executed. For example, the convergence condition is whether the performance evaluation index calculated by the process of step S6 is greater than a predetermined evaluation threshold. When the convergence condition is not satisfied (step S7, No), the hyperparameters are updated (step S8), returning to step S4.

When the convergence condition is satisfied (step S7, Yes), the output control module 17 outputs the model (step S9).

As described above, in the information processing device 1 of the embodiment, the storage unit 11 stores the time-series data including one or more variables. The time derivative value calculation module 12 calculates the time derivative value of the variable. The fluctuation difference calculation module 13 calculates the difference indicating the fluctuation of the long-term component of the variable based on the designated time sample interval. The estimation module 16 estimates the coefficient of the linear regression equation by the machine learning using the time derivative value and the difference as the learning data. Then, the output control module 17 outputs the linear regression equation.

With this configuration, the information processing device 1 of the embodiment can further improve the accuracy of generating the physical phenomenon model.

Note that the embodiment has described the case where the information processing device 1 generates the linear regression equation of the thermal model, but may generate the linear regression equation of other physical phenomenon model (for example, electrical resistance, physical deformation).

Finally, an example of a hardware configuration of the information processing device 1 of the embodiment will be described.

### Example of Hardware Configuration

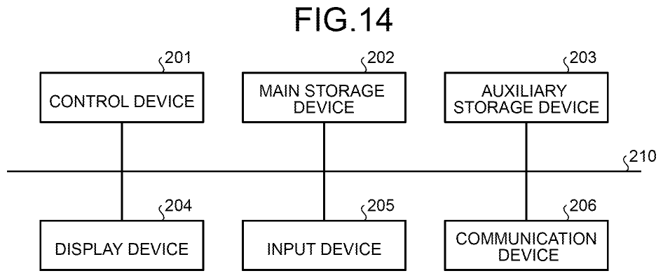

FIG. 14 is a diagram illustrating an example of the hardware configuration of the information processing device 1 of the embodiment.

The information processing device 1 of the embodiment includes a control device 201, a main storage device 202, an auxiliary storage device 203, a display device 204, an input device 205, and a communication device 206. The control device 201, the main storage device 202, the auxiliary storage device 203, the display device 204, the input device 205, and the communication device 206 are connected via a bus 210.

The control device 201 executes a program read from the auxiliary storage device 203 to the main storage device 202. The main storage device 202 is a memory such as a read-only memory (ROM) and a random-access memory (RAN). The auxiliary storage device 203 is a hard disk drive (HDD), a memory card, and the like.

The display device 204 displays display information. The display device 204 is, for example, a liquid crystal display or the like. The input device 205 is an interface for operating the information processing device 1. The input device 205 is, for example, a keyboard, a mouse, or the like. When the information processing device 1 is a smart device, such as a smartphone and a tablet-type terminal, the display device 204 and the input device 205 are, for example, a touch panel.

The communication device 206 is an interface for communicating with other devices and the like.

The program to be executed by the information processing device 1 of the embodiment is a file in an installable or executable format, and is recorded in a computer-readable storage medium such as a CD-ROM, memory card, CD-R, and DVD, and is provided as a computer program product.

A configuration may be adopted such that the program to be executed by the information processing device 1 of the embodiment is stored on a computer connected to a network such as the Internet and is provided by downloading via the network. A configuration may be adopted such that the program to be executed by the information processing device 1 of the embodiment is provided via a network such as the Internet without downloading.

A configuration may be adopted such that the program of the information processing device 1 of the embodiment is provided by being incorporated into a ROM or the like in advance.

The program to be executed by the information processing device 1 of the embodiment has a modular configuration including functional blocks that can also be implemented by the program among functional blocks described above (FIG. 3). As actual hardware of each of the functional blocks, the control device 201 reads and executes the program from a storage medium, whereby each of the functional blocks is loaded on the main storage device 202. That is, each of the functional blocks is generated on the main storage device 202.

Note that part or all of the functional blocks described above may not be implemented by software, but may be implemented by hardware such as an integrated circuit (IC).

When implementing each function by using a plurality of processors, each processor may implement one of the functions, or may implement two or more of the functions.

The operational mode of the information processing device 1 of the embodiment may be arbitrary. The information processing device 1 of the embodiment may operate, for example, as a cloud system on a network.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising:
a memory configured to store time-series data including one or more variables; and
one or more processors coupled to the memory and configured to:
calculate a time derivative value of each of the variables;
calculate a difference indicating fluctuation of a long-term component of the corresponding variable based on a designated time sample interval;
estimate a coefficient of a linear regression equation by machine learning using the time derivative value and the difference as learning data; and
output the linear regression equation.

2. The device according to claim 1, wherein
the one or more processors are configured to:
calculate the difference indicating the fluctuation of the long-term component based on two or more types of time sample intervals; and
estimate the coefficient of the linear regression equation by the machine learning using the time derivative value and two or more types of the differences indicating the fluctuation of the long-term component as the learning data.

3. The device according to claim 1, wherein
a sum total of the time derivative values included in the learning data is greater than a sum total of the differences.

4. The device according to claim 1, wherein
the one or more processors are further configured to:
generate a nonlinear function based on the variables; and
generate the linear regression equation with the nonlinear function as a basis function.

5. The device according to claim 4, wherein
the one or more processors are further configured to display a candidate for the basis function on a display device and receive designation of the basis function used to generate the linear regression equation from the candidate for the basis function.

6. The device according to claim 1, wherein
a value of each of the variables is represented in a unit unified for each physical quantity indicated by the corresponding variable.

7. An information processing method comprising:
storing time-series data including one or more variables;
calculating a time derivative value of each of the variables;
calculating a difference indicating fluctuation of a long-term component of the corresponding variable based on a designated time sample interval;
estimating a coefficient of a linear regression equation by machine learning using the time derivative value and the difference as learning data; and
outputting the linear regression equation.

8. A computer program product comprising a non-transitory computer-readable medium including programmed instructions, the instructions causing a computer to execute:
storing time-series data including one or more variables;
calculating a time derivative value of each of the variables;
calculating a difference indicating fluctuation of a long-term component of the corresponding variable based on a designated time sample interval;
estimating a coefficient of a linear regression equation by machine learning using the time derivative value and the difference as learning data; and
outputting the linear regression equation.
